(19) United States
(12) Patent Application Publication
(10) Pub. No.: US 2007/0006521 A1
(43) Pub. Date: Jan. 11, 2007

(54) Multi-phase candle

(75) Inventors: Michael Licciardello, Spartanburg, SC (US); Tommie Susanne Smith, Spartanburg, SC (US); Dennis Wayne Bartholomew, Aiken, SC (US)

Correspondence Address: DORITY & MANNING, P.A., POST OFFICE BOX 1449, GREENVILLE, SC, 29602-1449, US

(73) Assignee: BMC Manufacturing,LLC

(21) Appl. No.: 11/311,938

(22) Filed: Dec. 19, 2005

Related U.S. Application Data
(60) Provisional application No. 60/698,167, filed on Jul. 11, 2005.

(51) Int. Cl. C11C 5/00

(52) U.S. Cl. 44/275

(57) ABSTRACT

A multi-phase candle is provided that contains at least two contiguous phases that occupy separate and distinct physical spaces, and are not emulsified or mixed to any significant degree. The phases may possess a different color (including transparent and opaque phases). The contiguous phases of the candle are generally formed from respective wax compositions that are the same or different, and contain one or more waxes (including blends thereof).

### RELATED APPLICATIONS

The present application claims priority to U.S. Provisional Application No. 60/698,167, which was filed on Jul. 11, 2005.

### BACKGROUND OF THE INVENTION

Candles have enjoyed a significant increase in popularity over the past several years. As their popularity has risen, candles of many different types, shapes, and colors have been developed. For example, candles have been formed that contain multiple colored layers for providing a decorative effect. U.S. Patent Application Publication No. 2002/0168600 to McGee, et al. describes one such decorative candle that contains an opaque region and a transparent region. The decorative candle is formed by dispensing one material into a container, allowing the material to cool to form a first region, and thereafter, forming the other region. Unfortunately, such techniques for forming a colored candle are time-consuming, costly, and difficult to control in that they require multiple dispensing and cooling steps. As such, a need currently exists for an improved technique for forming a candle having multiple colors.

### SUMMARY OF THE INVENTION

In accordance with one embodiment of the present invention, a candle is disclosed that comprises first and second contiguous phases that are substantially immiscible and arranged in a three-dimensional spiral pattern. The first phase is formed from a first wax composition and the second phase is formed from a second wax composition. The first and second wax compositions each contain at least about 50 wt. % of at least one wax and have a viscosity of from about 500 to about 5000 centipoise, as measured with a Brookfield viscometer at a temperature of 39° C. and a spindle speed of 20 revolutions per minute.

In accordance with another embodiment of the present invention, a method for forming a candle is disclosed. The method comprises supplying a first wax composition and a second wax composition to a nozzle assembly, the first and second wax compositions each containing at least about 50 wt. % of at least one wax and having a viscosity of from about 500 to about 5000 centipoise, as measured with a Brookfield viscometer at a temperature of 39° C. and a spindle speed of 20 revolutions per minute. Relative rotation is induced between the nozzle assembly and a container. The first and second wax compositions are dispensed into the container to form the candle, the candle having first and second contiguous phases that are substantially immiscible.

Other features and aspects of the present invention are set forth in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a perspective view of one embodiment of a multi-phase candle of the present invention disposed within a container;

FIG. 2 illustrates the pitch and spiral angle parameters for the spiral pattern of the multi-phase candle shown in FIG. 1; and

FIG. 3 is a schematic illustration of one embodiment of a filling system that may be used in the present invention to form a multi-phase candle.

The figures are not necessarily to scale. Further, repeat use of reference characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction

Generally speaking, the present invention is directed to a multi-phase candle. As used herein, the term “multi-phase” generally refers to a composition having at least two contiguous phases that occupy separate and distinct physical spaces, and are not emulsified or mixed to any significant degree. The phases are also visually distinctive, e.g., they possess a different color (including transparent and opaque phases). One benefit of the present invention is the ability to arrange the phases in a variety of different patterns to achieve a desired aesthetic candle design. Exemplary patterns that may be formed in accordance with the present invention include, but are not limited to stripes, marbles, rectilinear, interrupted stripes, checkers, clustered, speckles, spots, ribbons, arrays, grooves, waves, sinusoidal, curves, cycles, streaks, striations, contours, laces, weaves, etc. In one particular embodiment, the phases are arranged in a three-dimensional spiral (“swirl”) pattern, such as a cylindrical spiral (i.e., helix), conical helix (i.e., vortex), and so forth. The stripes of the spiral pattern may be uniform or non-uniform across the dimension of the candle. Further, the spiral pattern may or may not extend across the entire dimension of the candle.

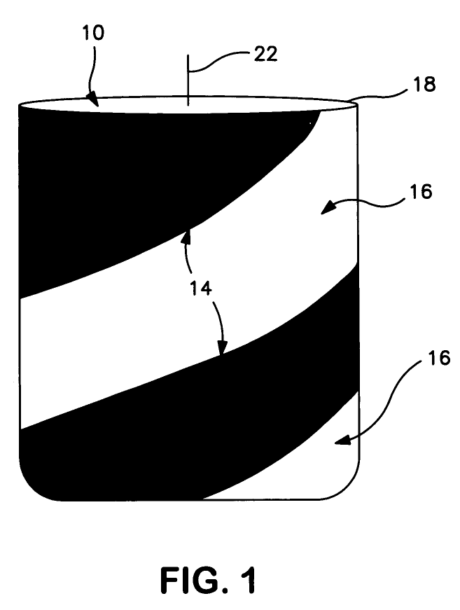

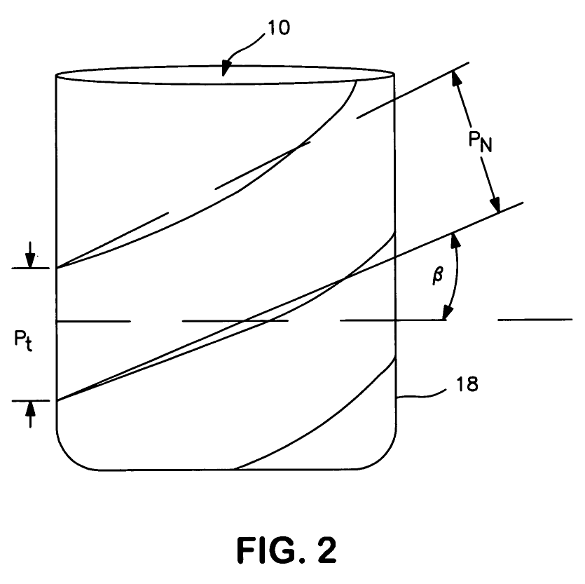

Referring to FIG. 1, for instance, one embodiment of a candle 10 that may be formed in accordance with the present invention is shown. As shown, the candle 10 is formed from two contiguous phases 16 and 18 that form a spiral pattern. Although two phases are shown, it should be understood that any number of phases may be employed in the present invention, such as three phases, four phases, etc. In this embodiment, each of the phases 16 and 18 are substantially continuous and extend across the entire dimension of the candle 10. The appearance and aesthetic appeal of the spiral pattern may be varied in the present invention by selectively controlling one or more geometrical parameters of the pattern. For instance, the direction of the spiral twist may be either left or right. In addition, the relative orientation (i.e., horizontal or vertical) of the spiral may also be varied to achieve a desired pattern. As shown in FIG. 2, for instance, the relative orientation of the spiral is dependent on the angle β. More specifically, smaller spiral angles β result in patterns that are more horizontal in nature, while larger angles result in patterns that are more vertical in nature. In most embodiments, the angle β ranges from 0° to about 90°, in some embodiments from about 10° to about 60°, and in some embodiments from about 30° to about 45°.

The number of stripes may also be varied to achieve a desired spiral pattern. For example, the number of stripes may vary from about 2 to about 50, in some embodiments from about 3 to about 25, and in some embodiments, from about 4 to about 12. In the embodiment shown in FIG. 1, for instance, each contiguous phase 16 and 18 forms two (2) stripes, such that the resulting spiral pattern contains a total of four (4) stripes. To achieve the desired number of stripes for a given candle size, the size of the spirals may be appropriately controlled. For instance, a spiral stripe has two related pitches, one in the plane of rotation (“ρₙ”) of the stripe and the other in a plane normal to the stripe (“ρₜ”) (FIG. 2). The number of stripes for a given candle size may be increased by reducing the pitch ρₙ and/or ρₜ. The pitch ρₙ may range from about 0.25 to about 10 centimeters, in some embodiments from about 0.5 to about 5 centimeters, and in some embodiments, from about 1 to about 2.5 centimeters. Likewise, the pitch ρₜ may range from about 0.25 to about 10 centimeters, in some embodiments from about 0.5 to about 5 centimeters, and in some embodiments, from about 1 to about 2.5 centimeters. As noted above, the radius and size of the stripes are not necessarily uniform across the entire spiral pattern. Thus, it should be understood that the spiral angle and pitch values referenced above represent only average values.

Referring again to FIG. 1, the candle 10 is also disposed within a container 18 (e.g., jar), although self-supporting candles (e.g., votives, tealights, tarts, pillars, etc.) candles are equally suitable for use in the present invention. The candle 10 may have any desired shape and/or size. In FIG. 1, for instance, the candle 10 has a circular base and sidewalls, with the container 18 having a shape and size corresponding to the shape and size of the candle 10. The container 18 may be made from any of a variety of materials, such as glass, ceramics, earthenware, metals, and so forth. The container 18 may be clear, opaque, translucent, or otherwise decorated. In addition, the container 18 also defines an opening through which the fragrance may be released. Although not shown, a top or lid may optionally be employed to cover the opening prior to the desired release of the fragrance. The lid may prevent the release of the fragrance, or it may contain one or more openings to allow the fragrance to dissipate therethrough. If desired, such a perforated lid may be employed during use to control the extent of the fragrance released to the surrounding environment. In addition, the candle 10 may also be provided with one or more air channels through which the evaporating fragrance is capable of passing. The candle 10 also includes a wick 22. The wick may be made from an absorbent material (e.g., cotton embedded with a metal) adapted for the transfer of the candle fuel by capillary action. Alternatively, the candle 10 may be wickless and instead be heated with a warming device, such as those that are electrically operated.

To reduce the likelihood of bleeding, it is normally desired that the contiguous phases are formed from compositions that are solid or semi-solid at room temperature (e.g., about 25° C.). In this regard, such phases are generally formed from one or more waxes. A “wax” is a natural or synthetic mixture of hydrocarbons and derivatives thereof that typically melts above 40° C. and is a solid or semi-solid at room temperature. Suitable waxes may include, for instance, insect and animal waxes, such as beeswax, lanolin, shellac wax, chinese insect wax, and spermaceti; vegetable waxes, such as carnauba, candelila, japan wax, ouricury wax, rice-bran wax, jojoba wax, castor wax, bayberry wax, sugar cane wax, soybean wax, palm wax and maize wax; petroleum waxes, such as petrolatum, paraffin wax, semi-microcrystalline wax, microcrystalline wax, ozokerite and ceresin waxes; synthetic waxes, such as polyethylene wax, Fischer-Tropsch wax, chlorinated naphthalene wax, substituted amide wax, ester waxes, and α-olefin wax; and blends thereof.

Petroleum waxes are particularly suitable for use in certain embodiments of the present invention. One example of such a wax is petrolatum (also known as petrolatum or mineral jelly). Petrolatum waxes are derived from heavy residual lube stock by propane dilution and filtering or centrifuging. They are microcrystalline in character, semi-solid at room temperature (e.g., about 25° C.) and are formed predominantly of saturated crystalline and liquid hydrocarbons having carbon numbers greater than C₂₅. Some suitable grades of petrolatum are available from The International Group, Inc. (“IGI”) of Wayne, Pa. under the names PETAX® 310 and 386 (medium consistency or hardness), as well as PETAX® 320, 321 and 387 (soft). PETAX® 310 has a melt transition point of from 51.7 to 60.0° C. (as determined by ASTM D 127).

Another example of a suitable petroleum wax is paraffin wax, which is a solid mixture of purified, saturated aliphatic hydrocarbons. Paraffin waxes are extracted from the high boiling fractions of crude petroleum during the refining process. Paraffin waxes are primarily formed from straight chain molecules with a small amount of branched-chain molecules having branching near the end of the chains. As a result of the long, straight chains, paraffin waxes have large, well-formed crystals. Although the melting (or congealing) point of paraffin waxes generally depends on the particular grade, most solid crystalline paraffin waxes have a melting point within a temperature range of about 50° C. to about 60° C. The degree of refinement may also influence the properties of the wax. For example, scale waxes have an oil content of from about 1.0 to about 3.0 wt. %, semi-refined paraffin waxes have an oil content of from about 0.5 to 1.0 wt. %, and fully refined paraffin waxes have an oil content of less than about 0.5 wt. %. Due to their low oil content, fully refined paraffin waxes are dry, hard, and capable of imparting good gloss, and thus often utilized in the present invention

Still another suitable petroleum wax for use in the present invention is microcrystalline wax (MC). Microcrystalline wax is generally composed of branched and cyclic hydrocarbons having carbon chain lengths of about 30 to about 100 and has melting point within the range of about 75° C. to about 85° C. Microcrystalline waxes differ from paraffin waxes with respect to their physical properties, chain structure and length, crystal type and in the process of manufacture. Further, they are generally tougher, more flexible and have a higher viscosity and melting points than paraffin waxes. Oil content varies with grade, but is usually between 2 to 12%.

Besides petroleum waxes, other types of waxes are also suitable for use in the present invention. For example, vegetable-derived waxes (“vegetable waxes”) may be employed to form one or more phases of the candle. Vegetable waxes are triacylglycerols formed by partially or fully hydrogenating vegetable oils. Suitable oils for use in forming vegetable waxes may include soybean, soy stearine, stearine, corn, cottonseed, rape, canola, sunflower, palm, palm kernel, coconut, crambe, linseed, peanut, and blends thereof. The vegetable oil may be hydrogenated to obtain a desired set of physical characteristics, e.g., melting point, solid fat content, and/or Iodine Value. For example, the vegetable wax typically has a melting point of about 49° C. to about 58° C., and in some embodiments, from about 50° C. to 55° C. Likewise, the vegetable wax typically has an Iodine Value of about 45 to 65, in some embodiments from about 50 to about 60, and in some embodiments, from about 52 to about 56. As is well known in the art, the Iodine Value is a measure of the amount of iodine absorbed in a given time by a compound or mixture and is an indication of the degree of unsaturation, or the number of double bonds. Other suitable vegetable waxes are also described in U.S. Pat. No. 6,824,572 to Murphy and U.S. Patent Application Publication No. 2005/0060927 to Murphy, which are incorporated herein in their entirety by reference thereto for all purposes.

The ability to form a candle with multiple phases depends generally on the nature of the wax compositions used to form each phase. Wax compositions that undergo substantial bleeding or mixing when placed adjacent to each other do not generally form separate and distinct phases. By carefully controlling the nature of the wax compositions used to form each phase, however, the present inventors have discovered that substantially immiscible, contiguous phases may be achieved. In one embodiment, for example, the materials used to form contiguous phases are selected for their inherent tendency to remain immiscible. Petroleum waxes (e.g., petrolatum and paraffin wax), for instance, are formed primarily from aliphatic hydrocarbons and are thus considered “non-polar.” When a non-polar wax is used to form one phase of the candle, a “polar” wax may likewise be selected to form a contiguous phase. One suitable polar wax is vegetable wax, which is a fatty acid containing hydroxy- and/or carboxy-groups that impart polarity to the wax molecule. Because polar waxes are generally immiscible in non-polar waxes, the contiguous phases are likewise immiscible.

Unfortunately, the formation of immiscible phases from polar and non-polar compositions typically requires the use of waxes having a certain difference in polarity. In many cases, however, it is desirable to use waxes that are either the same or closely similar so as to improve processing efficiency and reduce costs. In such embodiments, the present inventors have discovered that the desired immiscibility may still be achieved through selective control over the rheology of the compositions. Highly viscous compositions, for instance, are not generally miscible to any appreciable extent, and as such, may be used to form immiscible phases. Too high of a viscosity, however, may adversely affect the flowability of the material such that it is no longer easily processed. In this regard, the present inventors have discovered that the viscosity of the wax compositions may be controlled within a certain range to simultaneously achieve both flowability and immiscibility. More specifically, the viscosity may range from about 500 to about 5000 centipoise, in some embodiments from about 750 to about 3000 centipoise, and in some embodiments, from about 900 to about 2500 centipoise, as measured with a Brookfield viscometer at a temperature of 39° C. and a spindle speed of 20 rpm (spindle size 21).

A variety of techniques may be employed in the present invention to achieve the desired viscosity. For example, a viscosity modifier may be used in some embodiments of the present invention to reduce the viscosity of a wax. One particularly suitable class of viscosity modifiers that may be used in the present invention are esters oils, such as those having the formula R₁COOR₂ wherein R₁ is chosen from residues of higher fatty acids comprising from 1 to 44 carbon atoms and R₂ is chosen from hydrocarbonaceous chains comprising from 1 to 30 carbon atoms. Examples of such ester oils may include isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyldodecyl palmitate, oleyl oleate, oleyl erucate, erucyl oleate, erucyl erucate, and synthetic and natural mixtures of such esters, e.g. jojoba oil. Other suitable oils may include silicone oils, lanolins, adipic esters, butylene glycol diesters, dialkyl ethers or carbonates, saturated or unsaturated, branched alcohols, and fatty acid triglycerides, namely the triglycerol esters of saturated or unsaturated, branched or unbranched alkanecarboxylic acids with a chain length of from 8 to 24 carbon atoms. The fatty acid triglycerides may include, for instance, olive oil, sunflower oil, soybean oil, peanut oil, rapeseed oil, almond oil, palm oil, coconut oil, palm kernel oil, castor oil, wheat germ oil, grape seed oil, thistle oil, evening primrose oil, macadamian nut oil, and so forth. One particularly beneficial aspect of the present invention is that the viscosity modifier may also serve as an antiflaring agent. For instance, one class of viscosity modifiers that are also known to reduce flaring include stearic acid and the esters thereof, such as isopropyl isostearate, butyl stearate, hexadecyl stearate, isostearyl stearate, and mixtures thereof.

Many viscosity modifiers (e.g., oils) are liquids at room temperature. However, as noted above, it is normally desired that the contiguous phases remain a solid or semi-solid at room temperature. Thus, the relative amount of waxes and viscosity modifiers employed in the wax composition are generally balanced to an extent that the desired viscosity level is achieved without adversely affecting the solid or semi-solid properties of the composition. For example, the content of viscosity modifiers in a particular wax composition is generally less than about 20 wt. %, in some embodiments from about 1 wt. % to about 15 wt. %, and in some embodiments, from about 5 wt. % to about 10 wt. %. Likewise, the total amount of viscosity modifiers employed in the candle may also be less than about 20 wt. %, in some embodiments from about 1 wt. % to about 15 wt. %, and in some embodiments, from about 5 wt. % to about 10 wt. % of the candle. The content of waxes in a particular wax composition is also generally at least about 50 wt. %, in some embodiments from about 60 wt. % to about 95 wt. %, and in some embodiments, at least about 75 wt. % to about 90 wt. %. In addition, the total amount of waxes employed in the candle may be at least about 50 wt. %, in some embodiments from about 60 wt. % to about 95 wt. %, and in some embodiments, at least about 75 wt. % to about 90 wt. %.

When formed, the contiguous, substantially immiscible phases are generally visually distinguishable at a macroscopic level. One technique for providing the desired visual distinctiveness is to simply use contiguous phases having a different color. For instance, one phase may be red, blue, or green, while another phase may be white or yellow. To impart the desired color, the wax composition used to form the phase may include a colorant (e.g., pigment or dye). One class of suitable pigments, for instance, are organic pigments, such as azo, disazo, azomethine, methine, anthraquinone, phthalocyanine, perinone, perylene, diketopyrrolopyrrole, thioindigo, iminoisoindoline, dioxazine, iminoisoindolinone, quinacridone, flavanthrone, indanthrone, anthrapyrimidine, quinophthalone and blends thereof (e.g., azo/anthraquinone). Specific pigments that may be used are those described in the Color Index, including but not limited to C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 95, C.I. Pigment Yellow 109, C.I. Pigment Yellow 110, C.I. Pigment Yellow 147, C.I. Pigment Yellow 191.1, C.I. Pigment Yellow 74, C.I. Pigment Yellow 83, C.I. Pigment Yellow 13, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 29, C.I. Pigment Violet 37, C.I. Pigment Violet 19, C.I. Pigment Green 7, and C.I. Pigment Green 36. Inorganic pigments may also be employed, such as carbon black, iron oxide, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, and bismuth vanadate, titanium dioxide.

Generally, the colorant may be employed in any amount sufficient to impart the desired color. For instance, the colorant may constitute from about 0.001 wt. % to about 10 wt. %, in some embodiments from about 0.01 wt. % to about 5 wt. %, and in some embodiments, from about 0.1 wt. % to about 1 wt. % of a particular wax composition. Likewise, the total amount of colorant employed in the candle may also range from about 0.001 wt. % to about 10 wt. %, in some embodiment from about 0.01 wt. % to about 5 wt. %, and in some embodiments, from about 0.1 wt. % to about 1 wt. % of the candle.

Besides color, the visual distinctiveness of the contiguous phases may also be imparted in a variety of other ways. For instance, one phase may be transparent and another phase may be opaque. Alternatively, decorative items (“icons”) may be embedded within one or more phases of the candle to provide a desired aesthetic design. Different icons or patterns thereof may be embedded within the phases to provide the desired distinctiveness. Alternatively, icons may be embedded in one phase for contrasting with a contiguous phase that lacks such objects. Exemplary icons may include, for instance, beads, botanicals (e.g., flowers, flower petals, fruits, vegetables, plant parts, berries, twigs, leaves, and so forth), candy, lettering, or any other item have a desired shape, size, or decorative appeal.

Volatile fragrances may also be employed in one or more phases of the candle to provide a desired scent during use. As used herein, the term “volatile” or vaporizable substance refers to any material released from the candle to the surrounding atmosphere upon exposure to a certain amount of heat. The volatile fragrance typically has a vapor pressure that is greater than the vapor pressure of the gel at the “diffusion temperature”, which is the temperature under conditions of use at which the vaporizable substance diffuses into the surrounding atmosphere upon exposure to heat. For example, the volatile fragrance may begin to diffuse into the surrounding environment at temperatures of greater than about 60° C., in some embodiments greater than about 70° C., and in some embodiments, greater than about 80° C.

Any fragrance conventionally employed in scented candles, air fresheners, potpourri, perfumes, etc., may be employed in the present invention. For instance, some suitable fragrances may include myrrh, cedarwood, cedrenol, cedrol, birch, methyl salicylate, fir balsam, sandalwood, santalol, juniper, benzoin, coniferyl benzoate, thyme, thymol, bay, eugenol, myrcene, basil, camphor, methyl cinnamate, cinnamon, cinnamic aldehyde, rosemary, clove, and borneol. Still other suitable fragrances include limonene, α-terpinene, α-pinene, camphene, undecanol, 4-isopropylcyclohexanol, geraniol, linalool, citronellol, farnesol, menthol, 3-trans-isocamphylcyclohexanol, benzyl alcohol, 2-phenylethyl alcohol, 3-phenylpropanol, 3-methyl-5-phenylpentanol, cinnamic alcohol, isoborneol, thymol, eugenol, isoeugenol, anise alcohol, methyl salicylate, etc. Other suitable fragrances include aldehydes and ketones, such as hexanal, decanal, 2-methyldecanal, trans-2-hexenal, acetoin, diacetyl, geranial, citronellal, methoxydihydro-citronellal, menthone, carvone, camphor, fenchone, ionone, irone, damascone, cedryl methyl ketone, muscone, civetone, 2,4-dimethyl-3-cyclohexene carboxaldehyde, 2-heptylcyclopentanone, cis-jasmone, dihydrojasmone, cyclopentadecanone, benzaldehyde, phenylacetaldehyde, dihydrocinnamaldehyde, cinnamaldehyde, α-amylcinnamaldehyde, acetophenone, benzylacetone, benzophenone, piperonal, etc. Still other suitable fragrance compounds include esters, such as trans-2-hexenyl acetate, allyl 3-cyclohexylpropionate, methyl cinnamate, benzyl cinnamate, phenylethyl cinnamate, etc. Also, “spice”, “floral”, “fresh”, “ozone”, “baked”, “green”, “citrus”, “musk”, “woods”, and “balsam” fragrances, which are available from Bridgewater Candle Co. of Buffalo, S.C., may also be employed in the present invention.

The fragrance may be in liquid or solid form, such as a freeze-dried or encapsulated powder. Most conventional fragrance materials are volatile essential oils. Such oils may be synthetically or naturally derived. Naturally derived fragrant oils may include, for instance, bergamot, caraway, geranium, lavender, origanum, petitgrain, white cedar, patchouli, lavandin, neroli, rose absolute, and so forth. Synthetic fragrances may likewise include geraniol, geranyl acetate, isoeugenol, linalool, linalyl acetate, phenethyl alcohol, methyl ethyl ketone, methylionone, isobornyl acetate, etc. Still other synthetic fragrance compositions may be employed, either alone or in combination with natural oils, such as described in U.S. Pat. Nos. 4,324,915; 4,411,829; and 4,434,306, which are incorporated herein in their entirety by reference thereto for all purposes. In contrast to fragrant oils, crystalline or solid fragrances may sublime into the vapor phase at ambient temperatures. Exemplary crystalline fragrances include vanillin, ethyl vanillin, coumarin, tonalid, calone, heliotropene, musk xylol, cedrol, musk ketone benzophenone, raspberry ketone, methyl naphthyl ketone beta, phenyl ethyl salicylate, veltol, maltol, maple lactone, proeugenol acetate, evemyl, etc.

The amount of the volatile fragrance utilized generally depends on the nature of the fragrance and the degree to which it is desired that the candle release the fragrance. For example, the amount of the fragrance may range from about 0.1 wt. % to about 10 wt. %, in some embodiments from about 1 wt. % to about 8 wt. %, and in some embodiments, from about 2 wt. % to about 6 wt. % of a particular wax composition. Likewise, the total amount of fragrance employed in the candle may also range from about 0.1 wt. % to about 10 wt. %, in some embodiments from about 1 wt. % to about 8 wt. %, and in some embodiments, from about 2 wt. % to about 6 wt. % of the candle.

Besides fragrances, other volatile substances may also be released from the candle of the present invention. Representative examples of such volatile substances that may be released from the candle include insect repellants, medicaments, disinfectants, deodorants, cleansing agents, etc. Suitable insect repellents include, for instance, citronella, DEET, terpineol, and benzalacetone. As is well known in the art, the amount of such volatile substances may generally vary depending on the nature of the substance and the desired effect.

If desired, one or more phases of the candle may also include an ultraviolet (UV) stabilizer or absorber to reduce the amount of fragrance prematurely released. Any suitable UV absorber may be used in the present invention. Some examples of suitable UV absorbers include, for instance, benzotriazoles (e.g., 2-(2′-hydroxyphenyl)benzotriazoles), benzophenones (e.g., 2-hydroxybenzophenones), benzoxazinones, triazines (e.g., 2-(2-hydroxyphenyl)-1,3,5-triazines), phenyl salicylates, cinnamates, oxanilides, and so forth. Specific examples of suitable 2-(2′-hydroxyphenyl)benzotriazoles include 2-(2′-hydroxy-5′-methylphenyl)-benzotriazole; 2-(3′,5′-di-tert-butyl-2′-hydroxyphenyl)benzotriazole; 2-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxy-phenyl)-5-cholorobenzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)benzotriazole; 2-(2′-hydroxy-4′-octoxyphenyl)benzotriazole; 2-(3′,5′-di-tert-amyl-2′-hydroxyphenyl)benzotriazole; 2-(3′,5′-bis(α,α-dimethylbenzyl)-2′-hydroxyphenyl)-benzotriazole; a mixture of 2-(3′-tert-butyl-2′-hydroxy-5′-(2-octyloxycarbonylethly)-phenyl)-5-chloro-benzotriazole; 2-(3′-tert-butyl-5′-[2-(2-ethylhexyloxy)-carbonylethyl]-2′-hydroxyphenyl)-5-chloro-benzotriazole; 2-(3′-tert-butyl-2′-hydroxy-5′-(2-methoxycarbonylethyl)phenyl)-5-chloro-benzotriazole; 2-(3′-tert-butyl-2′-hydroxy-5′-(2-methoxycarbonylethyl)phenyl)benzotriazole; 2-(3′-tert-butyl-2′-hydroxy-5′-(2-octyloxycarbonylethyl)phenyl)benzotriazole; 2-(3′-tert-butyl-5′-[2-(2-ethyl hexyloxy)carbonylethyl]-2′-hydroxyphenyl)benzotriazole; 2-(3′-dodecyl-2′-hydroxy-5′-methylphenyl-)benzotriazole and 2-(3′-tert-butyl-2′-hydroxy-5′-(2-isooctyloxycarbonylethyl)phenylbenzotriazole; 2,2-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; and [R—CH₂CH—COO(CH₂)₃]₂ B, where R is 3′-tert-butyl-4′-hydroxy-5′-2H-benzotriazol-2-ylphenyl, and derivatives thereof.

In addition, specific examples of suitable 2-hydroxybenzophenones include 2-hydroxy-4-hydroxy-benzophenone; 2-hydroxy-4-methoxy-benzophenone; 2-hydroxy-4-octoxy-benzophenone; 2-hydroxy-4-decyloxy-benzophenone; 2-hydroxy-4-dodecylox-benzophenone; 2-hydroxy-4-benzyloxy-benzophenone; 2′,4,4′-trihydroxy-benzophenones; 2-hydroxy-4,4′-dimethoxy-benzophenone; 2,2′-dihydroxy-4-methoxybenzophenone; 2-hydroxy-4-n-octoxy-benzophenone, and derivatives thereof. Likewise, specific examples of suitable hindered hydroxybenzoate compounds include 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; and butyl-3-[3-t-butyl-4-(3,5-di-t-butyl-4-hydroxybenzoyloxy)phenyl]propionate. One particular example of a suitable UV absorber is a derivative of 2-hydroxy-4-hydroxy-benzophenone-5-sulfonic acid (i.e., a benzophenone derivative also known as “Benzophenone-4”), which is commercially available from BASF Corp. under the name Uvinul® MS-40.

When utilized, the UV absorber may be present in an amount of from about 0.001 wt. % to about 5 wt. %, in some embodiments from about 0.01 wt. % to about 1 wt. %, and in some embodiments from about 0.02 to about 0.1 wt. % of a particular wax composition. Likewise, the total amount of UV absorber employed in the candle may also range from about 0.001 wt. % to about 5 wt. %, in some embodiments from about 0.01 wt. % to about 1 wt. %, and in some embodiments, from about 0.02 wt. % to about 0.1 wt. % of the candle.

Generally speaking, any dispensing method and/or system capable of forming a multi-phase candle may be employed in the present invention. To form the desired spiral pattern, for example, a nozzle assembly may be employed that contains two or more nozzle heads. More specifically, each phase may be formed by simultaneously dispensing wax compositions through respective nozzle heads while rotating the nozzle assembly relative to the container. That is, either the nozzle assembly or the container may rotate. While undergoing relative rotation, the nozzle assemblies and container are also displaced vertically with respect to each other to form the desired spiral pattern. Again, either the nozzle assembly or the container may move in the vertical direction. One suitable example of such a nozzle system is available from Oden Corp. of Tonawanda, N.Y. under the name “SERVO/FILL Fully Automatic Liquid Filler (dual nozzle).” Still other suitable systems that may be adapted for use in the present invention are described in U.S. Pat. No. 5,996,650 to Phallen, et al.; U.S. Pat. No. 5,878,796 to Phallen; U.S. Pat. No. 5,797,436 to Phallen, et al.; and U.S. Pat. No. 5,168,905 to Phallen, which are incorporated herein in their entirety by reference thereto for all purposes.

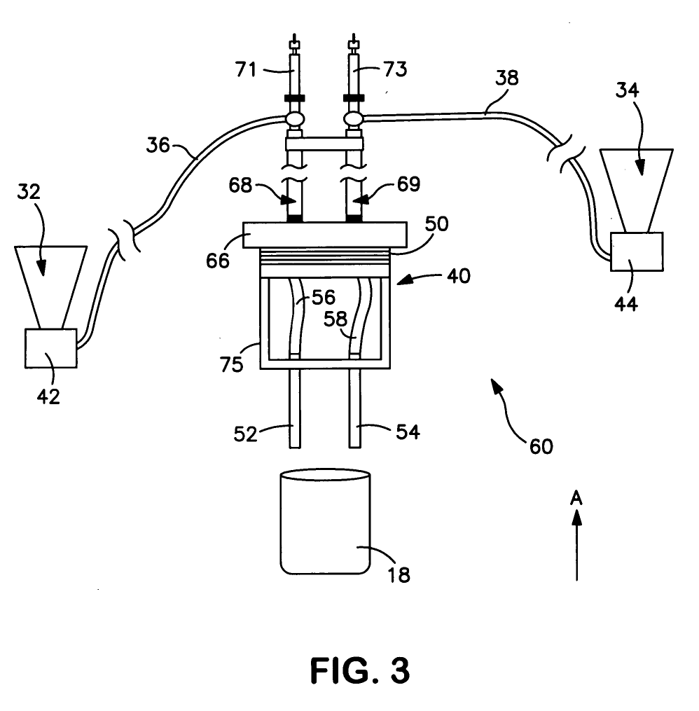

Referring to FIG. 3, for example, one particular method for forming a multi-phase jar candle in accordance with the present invention is schematically illustrated. In this embodiment, a liquid filling machine 60 is shown that includes first and second reservoirs 32 and 34, respectively, in which the wax compositions used to form contiguous phases are disposed. Of course, any number of reservoirs may be employed depending on the number and type of phases being formed. For example, when two phases are being formed from the same wax composition, only a single reservoir may be needed.

The reservoirs 32 and 34 are in communication with a filling nozzle assembly 40. The filling nozzle assembly 40 includes tubular portions 68 and 69 that communicate with positive shut-off valves 71 and 73, respectively. When open, the valves 71 and 73, respectively, permit flow from the reservoirs 32 and 34. The tubular portions 68 and 69 are received by a plate 66 where they are connected to nozzle heads 52 and 54 via conveying tubes 56 and 58, respectively. If desired, the conveying tubes 56 and 58 may be removed such that the tubular portions 68 and 69 are in direct communication with the nozzle heads 52 and 54. The nozzle assembly 40 also includes a disc 50 that is capable of rotating relative to the plate 66 up to 360° about an axis A. The disc 50 is coupled to a frame 75 that is likewise attached to the nozzle heads 52 and 54. Thus, rotation of the disc 50 actuates the rotation of the frame 75, conveying tubes 56 and 58, and the nozzle heads 52 and 54. If desired, the speed of rotation of the disc 50 may be selectively controlled to achieve a desired pattern for the candle. When forming a spiral pattern, for example, faster rotation speeds generally result in a greater number of stripes, a lower pitch, and a smaller spiral angle. In most embodiments of the present invention, the rotation speed is from about 50 to about 1000 revolutions per minute (rpm), in some embodiments from about 100 to about 750 rpm, and in some embodiments, from about 200 to about 500 rpm. Also, the filling nozzle assembly 40 is preferably interconnected with a diving mechanism (not shown) that permits the filling nozzle assembly 40 to move in a vertical direction. This allows the nozzle heads 52 and 54 to move into and retract from a container 18 during filling. For example, the nozzle heads 52 and 54 may retract away from the container 18 during filling to produce a spiral pattern. Regardless, the nozzle heads 52 and 54 allow the simultaneous dispensing of multiple phases to produce the desired spiral pattern. It should be understood that although two nozzle heads are shown in FIG. 3, any number of nozzle heads may be employed in the present invention. For example, four nozzle heads may be employed to form four contiguous phases. If desired, each of the four phases may have a different color, or two or more of the phases may have the same color. For example, two of the phases may have one color (e.g., red or green) and the other two phases may have another color (e.g., white).

The reservoirs 32 and 34 and filling nozzle assembly 40 are interconnected with each other by a flow control system. For instance, pumps 42 and 44 may be used in some embodiments of the present invention. Any known pump may be employed, such as rotary, gear, vane, lobe, circumferential piston, centrifugal, piston, and progressing cavity pumps. During the operation, a first wax composition may flow from the reservoir 32 to the pump 42, and then from the pump 42 through a conveying tube 36 to the tubular portion 68. Likewise, a second wax composition may flow from the reservoir 34 to the pump 44, and then from the pump 44 through a conveying tube 38 to the tubular portion 69.

Due to the viscous nature of the wax composition used in certain embodiments of the present invention, it is sometimes desired to heat the wax composition prior to dispensing it into the container 18. In this regard, the filling system 60 may employ a heating system that heats the composition within the reservoir and/or the filling nozzle assembly. Although not illustrated in FIG. 3, the system 60 may, for example, include a system in which hot air is introduced through a duct. Such an air heating system is described in more detail in U.S. Pat. No. 5,797,436 to Phallen, et al. Regardless of the particular manner in which the wax composition is heated, it is normally desired that the temperature of the composition remain below its melting point to avoid bleeding. For example, the temperature at which a wax composition may be filled is typically less than about 50° C., in some embodiments from about 20° C. to about 45° C., and in some embodiments, from about 25° C. to about 35° C. In fact, one beneficial aspect of the present invention is that filling may occur at room temperature (e.g., about 25° C.).

The present invention may be better understood with reference to the following examples.

### EXAMPLE 1

The ability to form a multi-phase candle in accordance with the present invention was demonstrated. Two wax compositions were initially formed as follows:

| | Composition A | Composition B |
|---|---|---|
| | (wt. %) | (wt. %) |
| Petrolatum* | 87 | 87 |
| Butyl stearate | 10 | 10 |
| Fragrance | 3 | 3 |

*obtained from The International Group, Inc. under the name “Petax 310.”

Each composition was formed by sequentially mixing the petrolatum, butyl stearate, and fragrance under agitation at a temperature of 21° C. to 26.7° C. Cyasorb® UV 5411 (a UV absorber available from Cytec Industries, Inc.) was then added to each composition in an amount of 0.2 wt. %. Red Liquid D-858 (red dye obtained from French Color & Chemical Co.) was also added to Composition A in an amount of 0.15 wt. %. Both compositions had a viscosity of between 850 to 920 centipoise, as measured with a Brookfield viscometer at a temperature of 39° C., a spindle speed of 20 rpm, and a spindle size of 21.

Upon formation, the compositions were then supplied to separate reservoirs of a dual nozzle filling system available from Oden Corp. of Tonawanda, N.Y. under the name “SERVO/FILL Fully Automatic Liquid Filler.” The nozzle rotation setting was between 250 to 450 units, the pump speed setting was 25%, and the volume setting was 3000 units. The compositions were maintained at a temperature of 21° C. to 26.7° C. prior to being dispensed from the nozzle. A 10-ounce glass jar was then filled and observed to have a visually distinct spiral pattern containing 5 to 6 stripes. The spiral angle Was between 250 to 300 and the pitch ρₜ was between 1.25 to 2.5 centimeters.

### EXAMPLE 2

The ability to form a multi-phase candle in accordance with the present invention was demonstrated. Two wax compositions were initially formed as follows:

| | Composition A | Composition B |
|---|---|---|
| | (wt. %) | (wt. %) |
| Petrolatum* | 87.0 | — |
| Vegetable/Paraffin blend** | — | 84.5 |
| Butyl stearate | 10.0 | 9.5 |
| Fragrance | 3.0 | 6.0 |

*obtained from The International Group, Inc. under the name “Petax 310.”
**obtained from The International Group, Inc. under the name “IGI 6006”, which is a solid vegetable/paraffin wax blend that congeals at a temperature of 56.1° C. (ASTM D 938).

Composition A was formed by sequentially mixing the petrolatum, butyl stearate, and fragrance under agitation at a temperature of 21° C. to 26.7° C. Composition B was formed by sequentially mixing the vegetable/paraffin blend, butyl stearate, and fragrance under agitation at a temperature of 54.4° C. Cyasorb® UV 5411 (a UV absorber available from Cytec Industries, Inc.) was then added to each composition in an amount of 0.2 wt. %. Red Liquid D-858 (red dye obtained from French Color & Chemical Co.) was also added to Composition A in an amount of 0.15 wt. %. Composition A had a viscosity of between 850 to 920 centipoise, as measured with a Brookfield viscometer at a temperature of 39° C., a spindle speed of 20 rpm, and a spindle size of 21. Composition B had a viscosity of between 850 to 940 centipoise, as measured with a Brookfield viscometer at a temperature of 45.1° C., a spindle speed of 20 rpm, and a spindle size of 21 (corresponding to 1100 to 1250 centipoise at 39° C.).

Upon formation, the compositions were then supplied to separate reservoirs of a dual nozzle filling system available from Oden Corp. of Tonawanda, N.Y. under the name “SERVO/FILL Fully Automatic Liquid Filler.” The nozzle rotation setting was between 200 to 400 units, the pump speed setting was 20 to 40%, and the volume setting was 3000 to 4000 units. Composition A was maintained at a temperature of 21° C. to 26.7° C. prior to being dispensed from the nozzle, while Composition B was maintained at a temperature of 40.6° C. to 43.3° C. A 10-ounce glass jar was then filled and observed to have a visually distinct spiral pattern containing 5 to 6 stripes. The spiral angle was between 250 to 300 and the pitch ρₜ was between 1.25 to 2.5 centimeters.

### EXAMPLE 3

The ability to form a multi-phase candle in accordance with the present invention was demonstrated. Two wax compositions were initially formed as follows:

| | Composition A | Composition B |
|---|---|---|
| | (wt. %) | (wt. %) |
| Petrolatum* | 42.25 | 42.25 |
| Vegetable/Paraffin blend** | 42.25 | 42.25 |
| Butyl stearate | 9.50 | 9.50 |
| Fragrance | 6.00 | 6.00 |

*obtained from The International Group, Inc. under the name “Petax 310.”
**obtained from The International Group, Inc. under the name “IGI 6006”, which is a solid vegetable/paraffin wax blend that congeals at a temperature of 56.1° C. (ASTM D 938).

Each composition was formed by sequentially mixing the petrolatum, vegetable/paraffin blend, butyl stearate, and fragrance under agitation at a temperature of 21° C. to 26.7° C. Cyasorb® UV 5411 (a UV absorber available from Cytec Industries, Inc.) was then added to each composition in an amount of 0.2 wt. %. Yellow Dye D-879 (obtained from French Color & Chemical Co.) was also added to Composition A in an amount of 0.15 wt. %, and Green Dye D-880 (French Color & Chemical Co.) was added to Composition B in an amount of 0.006 wt. %. Each composition also had a viscosity of between 2300 to 2450 centipoise, as measured with a Brookfield viscometer at a temperature of 39° C., a spindle speed of 20 rpm, and a spindle size of 21.

Upon formation, the compositions were then supplied to separate reservoirs of a dual nozzle filling system available from Oden Corp. of Tonawanda, N.Y. under the name “SERVO/FILL Fully Automatic Liquid Filler.” The nozzle rotation setting was between 300 to 400 units, the pump speed setting was 20 to 40%, and the volume setting was 4000 to 5000 units. Both compositions were maintained at a temperature of 21° C. to 26.7° C. prior to being dispensed from the nozzle. A 15-ounce glass jar was then filled and observed to have a visually distinct spiral pattern containing 6 stripes. The spiral angle was 300 and the pitch ρₜ was between 1.9 to 2.5 centimeters.

### EXAMPLE 4

Two wax compositions were initially formed as follows:

| | Composition A | Composition B |
|---|---|---|
| | (wt. %) | (wt. %) |
| Vegetable/Paraffin blend* | 84.5 | 84.5 |
| Butyl stearate | 9.5 | 9.5 |
| Fragrance | 6.0 | 6.0 |

*obtained from The International Group, Inc. under the name “IGI 6006”, which is a solid vegetable/paraffin wax blend that congeals at a temperature of 56.1° C. (ASTM D 938).

Each composition was formed by sequentially mixing the vegetable/paraffin blend, butyl stearate, and fragrance under agitation at a temperature of 54.4° C. Cyasorb® UV 5411 (a UV absorber available from Cytec Industries, Inc.) was then added to each composition in an amount of 0.2 wt. %. Red Liquid D-858 (red dye obtained from French Color & Chemical Co.) was also added to Composition A in an amount of 0.15 wt. %. Each composition had a viscosity of between 850 to 940 centipoise, as measured with a Brookfield viscometer at a temperature of 45.1° C., a spindle speed of 20 rpm, and a spindle size of 21 (corresponding to 1100 to 1250 centipoise at 39° C.). Both compositions were cooled to a temperature of 40.6° C. to 43.3° C. and then dispensed into a 10-ounce glass jar. The resulting candle was observed to have a visually distinct spiral pattern.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A candle comprising first and second contiguous phases that are substantially immiscible and arranged in a three-dimensional spiral pattern, wherein the first phase is formed from a first wax composition and the second phase is formed from a second wax composition, the first and second wax compositions each containing at least about 50 wt. % of at least one wax and having a viscosity of from about 500 to about 5000 centipoise, as measured with a Brookfield viscometer at a temperature of 39° C. and a spindle speed of 20 revolutions per minute.

2. The candle of claim 1, wherein the first wax composition, the second wax composition, or both comprise from about 60 wt. % to about 90 wt. % of at least one wax.

3. The candle of claim 1, wherein the first wax composition, the second composition, or both comprise petroleum wax, vegetable wax, or blends thereof.

4. The candle of claim 3, wherein the first wax composition, the second composition, or both comprise petrolatum, paraffin wax, microcrystalline wax, or blends thereof.

5. The candle of claim 1, wherein the first wax composition comprises a polar wax and the second wax composition comprises a nonpolar wax.

6. The candle of claim 5, wherein the polar wax is vegetable wax and the nonpolar wax is petroleum wax.

7. The candle of claim 1, wherein the first and second wax composition each have a viscosity of from about 750 to about 3000 centipoise, as measured with a Brookfield viscometer at a temperature of 39° C. and a spindle speed of 20 revolutions per minutes.

8. The candle of claim 1, wherein the first and second wax composition each have a viscosity of from about 900 to about 2500 centipoise, as measured with a Brookfield viscometer at a temperature of 39° C. and a spindle speed of 20 revolutions per minute.

9. The candle of claim 1, wherein the first wax composition, the second wax composition, or both comprise a viscosity modifier.

10. The candle of claim 9, wherein the viscosity modifier comprises an ester oil.

11. The candle of claim 9, wherein the viscosity modifier constitutes less than about 20 wt. % of the first wax composition, the second wax composition, or both.

12. The candle of claim 9, wherein the viscosity modifier constitutes from about 1 to about 15 wt. % of the first wax composition, the second wax composition, or both.

13. The candle of claim 1, wherein the first and second phases are visually distinctive.

14. The candle of claim 13, wherein the first phase has a different color than the second phase.

15. The candle of claim 1, wherein the first wax composition, the second wax composition, or both comprise a colorant, fragrance, ultraviolet stabilizer, or combinations thereof.

16. The candle of claim 1, wherein the spiral pattern defines a spiral angle of from 0° to about 90°.

17. The candle of claim 1, wherein the spiral pattern defines a spiral angle of from about 30° to about 45°.

18. The candle of claim 1, wherein the spiral pattern defines from about 2 to about 50 stripes.

19. The candle of claim 1, wherein the spiral pattern defines from about 4 to about 12 stripes.

20. The candle of claim 1, wherein the spiral pattern defines at least one stripe having a pitch in a plane normal to the stripe of from about 0.25 to about 10 centimeters.

21. The candle of claim 1, wherein the spiral pattern defines at least one stripe having a pitch in a plane normal to the stripe of from about 1 to about 2.5 centimeters.

22. The candle of claim 1, wherein the first and second phases are disposed within a container.

23. The candle of claim 1, further comprising a wick.

24. The candle of claim 1, further comprising an additional phase.

25. A candle comprising first and second contiguous phases that are substantially immiscible and arranged in a three-dimensional spiral pattern, wherein the first phase is formed from a first wax composition and the second phase is formed from a second wax composition, the first and second wax compositions each containing from about 60 wt. % to about 95 wt. % of at least one wax, each wax composition also having a viscosity of from about 500 to about 5000 centipoise, as measured with a Brookfield viscometer at a temperature of 39° C. and a spindle speed of 20 revolutions per minute.

26. The candle of claim 25, wherein the first wax composition, the second composition, or both comprise petroleum wax, vegetable wax, or blends thereof.

27. The candle of claim 25, wherein the first wax composition comprises a polar wax and the second wax composition comprises a nonpolar wax.

28. The candle of claim 26, wherein the polar wax is vegetable wax and the nonpolar wax is petroleum wax.

29. The candle of claim 25, wherein the first and second wax composition each have a viscosity of from about 750 to about 3000 centipoise, as measured with a Brookfield viscometer at a temperature of 39° C. and a spindle speed of 20 revolutions per minute.

30. The candle of claim 25, wherein the first and second wax composition each have a viscosity of from about 900 to about 2500 centipoise, as measured with a Brookfield viscometer at a temperature of 39° C. and a spindle speed of 20 revolutions per minute.

31. The candle of claim 25, wherein the first and second phases are visually distinctive.

32. The candle of claim 31, wherein the first phase has a different color than the second phase.

33. A method for forming a candle, the method comprising:
supplying a first wax composition and a second wax composition to a nozzle assembly, the first and second wax compositions each containing at least about 50 wt. % of at least one wax and having a viscosity of from about 500 to about 5000 centipoise, as measured with a Brookfield viscometer at a temperature of 39° C. and a spindle speed of 20 revolutions per minute;
inducing relative rotation between the nozzle assembly and a container; and
dispensing the first and second wax compositions into the container to form the candle, the candle having first and second contiguous phases that are substantially immiscible.

34. The method of claim 33, wherein the nozzle assembly is rotated relative to the container.

35. The method of claim 33, wherein the nozzle assembly rotates at a speed of from about 50 to about 1000 revolutions per minute.

36. The method of claim 33, wherein the nozzle assembly rotates at a speed of from about 200 to about 500 revolutions per minute.

37. The method of claim 33, wherein the first and second wax compositions are dispensed while the nozzle assembly is moved away from the container in a vertical direction.

38. The method of claim 33, wherein the temperature of the first wax composition, the second wax composition, or both is from about 20° C. to about 45° C. before being dispensed into the container.

39. The method of claim 33, wherein the temperature of the first wax composition, the second wax composition, or both is from about 25° C. to about 35° C. before being dispensed into the container.

40. The method of claim 33, wherein the first wax composition, the second composition, or both comprise petroleum wax, vegetable wax, or blends thereof.

41. The method of claim 33, wherein the first and second wax composition each have a viscosity of from about 750 to about 3000 centipoise, as measured with a Brookfield viscometer at a temperature of 39° C. and a spindle speed of 20 rpms.

42. The method of claim 33, wherein the first and second wax composition each have a viscosity of from about 900 to about 2500 centipoise, as measured with a Brookfield viscometer at a temperature of 39° C. and a spindle speed of 20 rpms.

43. The method of claim 33, wherein the first and second phases are visually distinctive.

44. The method of claim 43, wherein the first phase has a different color than the second phase.

45. The method of claim 33, wherein the first and second phases are arranged in a three-dimensional spiral pattern.
